(19) United States
(12) Patent Application Publication
(10) Pub. No.: US 2008/0143057 A1
(43) Pub. Date: Jun. 19, 2008

(54) Protective sleeve for use with ratcheting winch or cap

(75) Inventors: Howard Thomas Knox, Hebron, KY (US); Thomas H. Leone, Burlington, KY (US)

Correspondence Address: EDWARD A SOKOLSKI, 3868 CARSON STREET, 105, TORRANCE, CA, 90503, US

(73) Assignee: ANCRA INTERNATIONAL, LLC.

(21) Appl. No.: 11/640,032

(22) Filed: Dec. 15, 2006

(51) Int. Cl. F16J 15/54

(52) U.S. Cl. 277/634

(57) ABSTRACT

A protective sleeve for protecting a ratchet cap or winch from damage or deterioration due to dirt of moisture is fabricated of a sturdy yet elastic material, which may be rubber. The sleeve is cylindrical in form and has circular grooves, which run parallel to each other formed on the inner surface of the sleeve. Cylindrical bars separate the grooves from each other. Mating grooves to those formed on the sleeve are formed on the ratchet cap or winch. The sleeve is installed in position on the cap or winch by forcing it into position over the cap or winch with the bars of the sleeve installed in the grooves of the cap or winch and the bars of the cap or winch installed in the grooves of the sleeve. This provides for firm retention of the sleeve in its installed position and permits relative rotation between the elements of the ratcheting member, yet the sleeve can readily be removed from its installed position without damage thereto.

### BACKGROUND OF THE INVENTION

1. Field of the Invention

This invention relates to protective sleeves for protecting ratcheting winches and caps from damage and deterioration and more particularly to such a device which is flexible and tightly fits onto a winch or cap yet which can readily be removed therefrom and still allows for easy rotation between the two elements of the winch cap.

2. Description of the Related Art

Various protective devices for equipment of one sort or the other are described in the prior art. These include the devices of U.S. Pat. No. 6,112,770 issued Sep. 5, 2000 to Walsh et al; U.S. Pat. No. 3,581,776 issued Jun. 1, 1971 to Sheehan; U.S. Pat. No. 4,688,890 issued Aug. 25, 1987 to De Meo et al. and U.S. Pat. No. 3,240,233 issued Mar. 15, 1966 to Johnston.

While all of these prior art devices appear to provide adequate protection for the pieces they fit onto, they have the following shortcomings. First, they do not fit onto the pieces they protect in a manner, which enables ready removal, and reuse when such removal is required to repair the piece they protect. With some of these devices it appear necessary to cut the protective away and replace it with a new such device. Further, some of these devices do not appear to provide the tight retention on the pieces they protect as is often necessary to provide proper protection

### SUMMARY OF THE INVENTION

The protective sleeve of the present invention is fabricated of a sturdy yet elastic rubber material which when placed in position on a ratchet cap or ratcheting winch holds firmly in position yet can be removed without any great difficulty. The device of the invention is in the form of a cylindrical sleeve with an inner diameter substantially equal to the diameter of the cap or winch and having grooves running circularly around the inner surface thereof. These grooves are substantially parallel to each other and are separated from each other by cylindrical bars. Mating grooves and bars to those on the sleeve are formed around the surfaces of the winch and cap.

The Protective sleeve is force into position over the cap or winch to bring the corresponding bars of the sleeve into the mating grooves of the winch or cap and the bars of the cap or winch into the mating engagement with the corresponding grooves of the sleeve. This provides firm engagement of the cap with the cap or winch, yet permits easy rotation between the two elements of the winch cap and allows removal of the sleeve from the winch or cap without damage thereto.

### DESCRIPTION OF THE DRAWINGS

FIG. 1 is a side elevational view, partially in cross-section of a first embodiment of the invention;

FIG. 2 is a top perspective exploded view of the first embodiment;

FIG. 3 is a cross sectional view taken along the plane indicated by 3-3 in FIG. 2;

FIG. 4 is a side elevational view partly in cross section of a second embodiment of the invention;

FIG. 5 is a side elevational view partly in cross section of a third embodiment of he invention;

FIG. 6 is a side elevational view, partly in cross section of a fourth embodiment of the invention; and

FIG. 7 is a side elevational view, partly in cross section of a fifth embodiment of the invention.

### SPECIFICATION

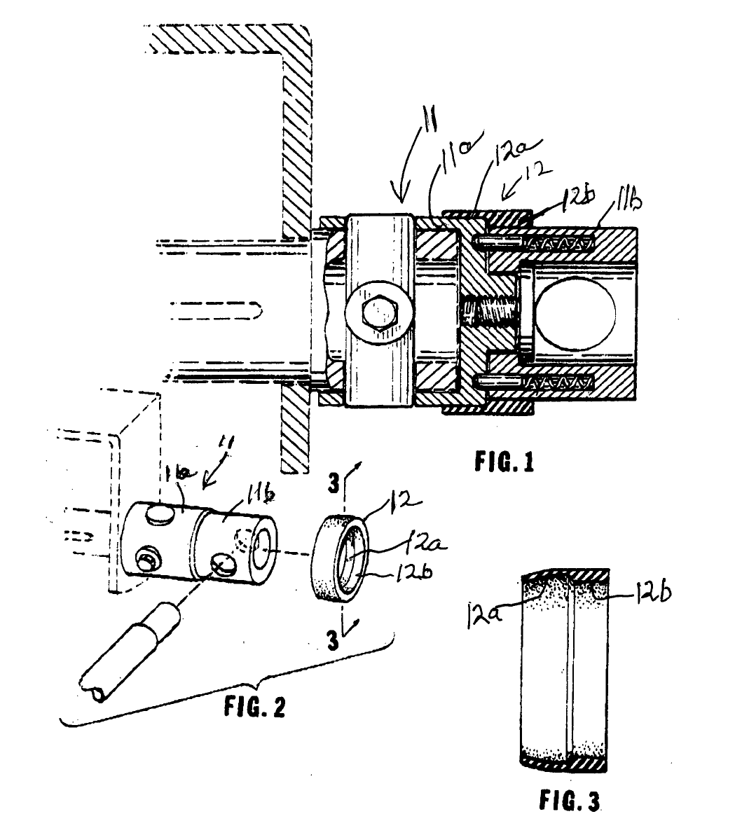

Referring to FIGS. 1-3, a first embodiment of the invention is illustrated. Ratchet cap 11 has a first cylindrical portion 11a which is attached to a second cylindrical portion 11b. Portion 11a has a slightly greater diameter than portion 11b. so that where they join together, a vertical step is formed there between. Protective sleeve 12 is cylindrical and has a first portion 12a, with a slightly greater inner diameter than a second portion 12b. First portion 12a is curved inwardly. The sleeve is fabricated of sturdy elastic material, which may be rubber. The two portions 12a and 12b of the sleeve fit tightly over portions 11a and 11b of the ratchet cap respectively. The inwardly curved portion of the sleeve 12b fits very tightly over ratchet cap 11b. This provides tight protective retention of the protective sleeve on the ratchet cap, yet permits its ready removal for replacement or for repair of the ratchet cap or related parts.

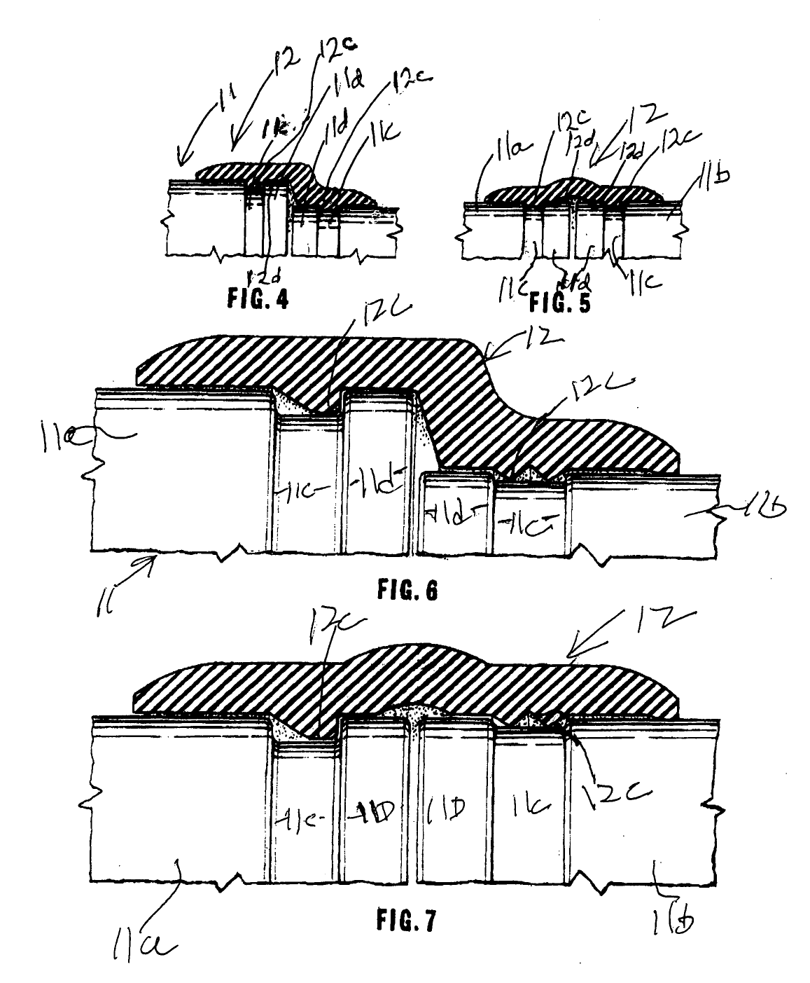

Referring now to FIG. 4, a second embodiment of the invention is illustrated. In this embodiment, the ratchet cap 11 has cylindrical grooves 11c formed therein, these grooves being separated from each other by cylindrical bars 11d. The protective sleeve 12 fits tightly over the ratchet cap. The protective sleeve has cylindrical projections 12c which matingly engage the grooves 11c of the ratchet cap and cylindrical grooves 12d, which matingly engage the grooves 11d of the ratchet cap. As in the prior embodiment the end portions 11e are curved inwardly to provide a tight grasp on the ratchet cap.

Referring now to FIG. 5, a further embodiment of the invention is illustrated. This embodiment is used where the two portions 11a and 11b of the ratchet cap have the same diameter. The structure and operation is the same as that of the prior embodiment except that the sleeve has a central raised portion, which fits, over the space between the two portions of the ratchet cap. The cylindrical bars 12c and grooves 12d of the sleeve matingly engage the cylindrical grooves 11c and bars 11d of the cap.

Referring now to FIG. 6, a further embodiment of the invention is shown. In this embodiment, rather than providing rectangular shaped cylindrical bars 12c on the sleeve, the bars rather have bottom ends, which are triangular. This provides firm retention in the grooves of the cap yet facilitates rotation of ratchet cap portion 11b relative to cap portion 11 as well as facilitating removal of the sleeve from the cap.

Referring now to FIG. 7, a still further embodiment of the invention is shown. This embodiment is employed where the ratchet cap portions have substantially the same diameter. As for the embodiment of FIG. 6, the bottom ends of the cylindrical bars 12c have triangular configurations and the central portion of the sleeve, which runs between the ratchet cap portions, is raised.

We claim:

1. A device for protecting a ratcheting member comprising:
a cylindrical sleeve fabricated of an elastic material, said sleeve having an inner diameter substantially equal to the outer diameter of said ratcheting member,
a cylindrical bar formed on the inner surface of the sleeve; and
a cylindrical groove running around the outer surface of said ratcheting member, said bar having a width substantially equal to the width of said groove;
said sleeve fitting tightly over said ratcheting member with the bar of said sleeve fitted within the groove of said ratcheting member.

2. The device of claim 1 and further including a second bar formed on the inner surface of the sleeve, the groove of said sleeve being positioned between said sleeve bars, and a second groove being formed on the outer surface of said ratcheting member, said grooves and said bars each having substantially the same width, the bars of said cylindrical sleeve each being fitted in mating engagement with an oppositely positioned one of said grooves of said ratcheting member and the bars of said ratcheting member each being fitted in mating engagement with an oppositely positioned one of said grooves of said sleeve.

3. The device of claim 1 wherein said sleeve is fabricated of rubber.

4. A device for protecting a cylindrical ratcheting winch and a cylindrical cap, said cap having a different outer diameter than said winch comprising:
a cylindrical sleeve fabricated of an elastic material, said sleeve having a first portion with an inside diameter substantially equal to that of the outer diameter of said cap and a second portion with an inside diameter substantially equal to the outer diameter of said winch;
a cylindrical bar formed on the outer surface of said winch, a cylindrical groove formed on the outer surface of said winch adjacent to the bar member formed thereon;
a cylindrical bar formed on the outer surface of said cap, a cylindrical groove member formed on the outer surface of said cap adjacent to the bar member formed thereon;
a cylindrical bar formed on the inner wall of the first portion of said cylindrical sleeve, a groove formed on the inner wall of said first portion of said cylindrical sleeve adjacent to the bar member of said first portion;
a cylindrical bar formed on the inner wall of the second portion of said cylindrical sleeve;
a groove formed on the inner wall of said second portion of said cylindrical sleeve adjacent to the bar member of the second portion;
the bars and grooves formed in the sleeve, the cap and the winch all having substantially the same width;
the bar and groove of said first sleeve portion being fitted in mating engagement with the groove and bar of said cap and the bar member and groove of said second sleeve being fitted in mating engagement with the groove and bar members of said winch.

5. The device of claim 4 wherein said winch and said first portion of said sleeve has a greater outer diameter than said cap and said second portion of said sleeve.

6. The device o claim 4 wherein said sleeve is fabricated of rubber.

7. The device of claim 4 wherein the cylindrical bar of at one of said cylindrical portions has a triangular bottom end.
